(19) United States
(12) Patent Application Publication
(10) Pub. No.: US 2004/0219856 A1
(43) Pub. Date: Nov. 4, 2004

(54) Composite support with fire resistance property for bituminous roofing sheaths

(76) Inventor: Achille Locatelli, Blevio (IT)

Correspondence Address: WENDEROTH, LIND & PONACK, L.L.P., 2033 K STREET N. W., SUITE 800, WASHINGTON, DC, 20006-1021, US

(21) Appl. No.: 10/469,308

(22) PCT Filed: Mar. 4, 2002
(86) PCT No.: PCT/EP02/02476

(30) Foreign Application Priority Data
Mar. 8, 2001 (IT) MI02A000489

(51) Int. Cl. D04H 3/05; D04H 1/74; B32B 5/26; B32B 27/02

(52) U.S. Cl. 442/367; 442/366; 442/392; 442/394

(57) ABSTRACT

The present invention refers to a composite support with fire resistance property for bituminous roofing sheaths. The composite support (9) comprises a first (1) and a second (7) layer of non-woven synthetic material met and a glass film (6) interposed between said layers (1, 7), between which a plurality of longitudinally oriented reinforcing glass filaments (4) are interposed.

The present invention refers to a composite support with fire resistance property for bituminous roofing sheaths.

The use of non-woven sheaths in chemical textile material, for instance polyester, is known in order to provide a support for bituminous roofing sheaths.

It is also well known to provide such supports by means of two non-woven layers comprising reinforcing filaments, in particular glass filaments as described in Italian Patent 1237149.

EP 667427 teaches an association of two non-woven layers with interposition of a glass film, which has the task to create a barrier to the fire and to the leaking of bitumen in case a fire develops over the roof

However it was found that both during the stage of production of the composite support and in the stage of impregnation with bitumen, the different degree of dimensional variation of the non-woven layers and the glass film causes the formation of fissures or cracks in the same film, that nullify the fire resistance property of the support.

In view of the state of the art described, scope of the present invention is to provide a composite support with fire resistance property for bituminous roofing sheaths, that is capable to obviate to the disadvantages of the known technique.

According to the present invention, such scope is attained by means of a composite support for bituminous sheaths comprising a first and a second layer of non-woven synthetic material mat and a glass film interposed between said layers, characterised in that it additionally comprises between said first and second mat layers a plurality of longitudinally oriented reinforcing glass filaments.

Owing to the present invention it is possible to provide a composite support for bituminous sheaths that is capable to offer a greater resistance to fire, as compared with the known products.

In fact the glass filaments guarantee, both in the stage of production of the support and in the stage of impregnation with bitumen, the non-lengthening of the non-woven layers with respect to the glass film, with consequent greater resistance to the formation of fissures or cracks of the latter and equally consequent improvement of its fire resistance property.

The characteristics and the advantages of the present invention will become evident from the following detailed description an embodiment thereof, that is illustrated as non limiting example in the enclosed drawings, in which:

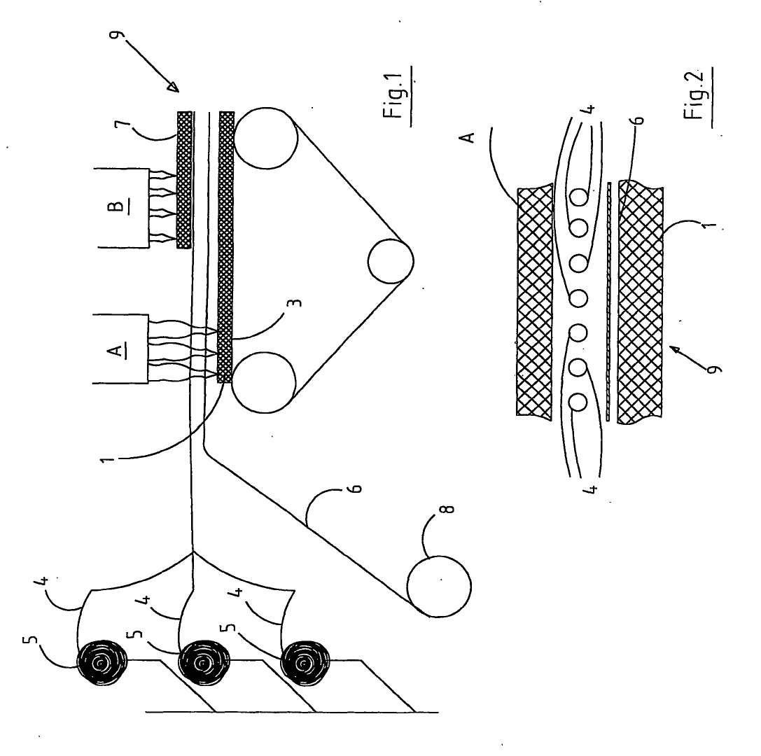

FIG. 1 shows schematically an embodiment of the production process of the composite support according to the present invention;

FIG. 2 shows the composite support according to the present invention in transversal section.

According to what outlined in FIG. 1 a first layer 1 of non-woven fabric, in particular polyester polymer, is fed by a first extrusion head A onto a conveyor belt 3.

A plurality of longitudinal reinforcing glass filaments 4 and a glass film 6 are superimposed onto the non-woven layer 1.

In particular said reinforcing glass filaments 4 are unwound from coils 5 thanks to appropriate traction means (not shown in figure). The glass film 6 in turn is unwound from a coil 8.

Onto the group above described a second layer 7 of non-woven fabric, of the same material as before, is placed that is fed by a second extrusion head B.

A composite support 9 is thus obtained, shown in section in FIG. 2, in which the glass film 6 is located inside the two non-woven layers 1 and 7 that are in turn reinforced in longitudinal sense by the filaments of reinforcing glass 4.

The presence of the reinforcing glass filaments 4 guarantees, both in the stage of production and in the stage of impregnation with bitumen of the composite support, the non-lengthening of the layers 1 and 7, thus preventing the fissuring or cracking in the glass film 6.

This guarantees that in case of fire the inflamed bitumen does not leak between the fissure of the glass film 6, and therefore that the fire does not propagate inside the building.

Therefore the quality of the product thus obtained allows to provide an effective fire resistant barrier.

In addition it should be noted that the invention can be machined in the stage of the impregnation with bitumen even at high temperatures, since the reinforcing glass filaments 4 prevent the stress of the chemical material that makes up the layers 1 and 7.

1. Composite support for bituminous roofing sheaths comprising a first (1) and a second (7) layer of non-woven synthetic material mat and a glass film (6) interposed between said layers (1, 7), characterised in that it additionally comprises between said first (1) and second (7) mat layers a plurality of longitudinally oriented reinforcing glass filaments (4).

2. Composite support according to claim 1, characterised in that said first (1) and second (5) mat layers are made by extrusion of polymer polyester.
